(19) United States
(12) Patent Application Publication
(10) Pub. No.: US 2008/0213631 A1
(43) Pub. Date: Sep. 4, 2008

(54) Hybrid Power Strip

(75) Inventors: Sivaramakrishnan Krishnamoorthy, Lake Zurich, IL (US); Aditya Bedekar, Hutsville, AL (US); Jianjun Wei, Madison, AL (US)

Correspondence Address: TOMAS FRIEND, LLC, 904 BOB WALLACE AVENUE, SUITE 228, HUNTSVILLE, AL, 35801, US

(73) Assignee: CFD RESEARCH CORPORATION, Huntsville, AL (US)

(21) Appl. No.: 11/868,219

(22) Filed: Oct. 5, 2007

Related U.S. Application Data
(60) Provisional application No. 60/858,590, filed on Nov. 13, 2006.

(51) Int. Cl. H01M 8/16; H01M 8/10; H01M 8/04

(52) U.S. Cl. 429/2; 429/30; 429/13

(57) ABSTRACT

The present invention is a flexible hybrid biofuel cell power strip for use in low power applications (less than one Watt) such as trickle charging to extend the charge of conventional batteries or to power devices such as microsensors, micropumps and miniaturized medial devices. The power strip anode comprises carbon nanotubes (CNTs) that transfer electrons directly from the active center of an oxidation-reduction (redox) enzyme to a flexible, conductive anode substrate. This allows the building of surface architectures with pore structures customized for specific applications and enzyme substrate-containing media. The cathode comprises a catalytic layer of transition metal nanoparticle catalyst in contact with air or other source of oxygen. The flexibility of the power strip allows it to be shaped into a wide variety of conformations and applications, including attachment to or implantation within living organisms.

### CROSS-REFERENCE TO RELATED APPLICATIONS

This application claims priority under 35 U.S.C. 119(e) to provisional Application No. 60/858,590, filed Nov. 13, 2006.

### STATEMENT REGARDING FEDERALLY SPONSORED RESEARCH OR DEVELOPMENT

The U.S. Government has rights in this invention pursuant to SBIR Contract No. W911SR04C0071 awarded by the U.S. Army

### INCORPORATED-BY-REFERENCE OF MATERIAL ON A CD

Not Applicable

### BACKGROUND OF THE INVENTION

1. Field of the Invention

The present invention pertains to the field of biological fuel cells and hybrid fuel cells that involve biologically catalyzed reactions at one electrode and non-biologically catalyzed reactions at the other electrode. More specifically, the invention is a flexible, hybrid fuel cell power strip.

2. Description of Related Art

Portable power supplies can be categorized as batteries or fuel cells. Fuel cells normally involve the catalytic reduction of oxygen to form water combined with the oxidation of hydrogen or a hydrocarbon fuel such as methanol. Biological fuel cells, or biofuel cells, are devices that convert biochemical energy directly into electrical energy. They are distinguished from conventional fuel cells by the use of biocatalysts such as enzymes or microbes to generate electricity from organic substrates. Fuel is oxidized by one or more biochemical reactions at the anode of the cell, while oxygen is reduced at the cathode to generate water. The simultaneous oxidation and reduction reactions at the anode and cathode can produce electricity at near neutral pH and ambient temperature.

A hybrid biofuel cell combines a biological process at either the cathode or the anode with a non-biologically catalyzed reaction at the other electrode. Some biofuel cells use an “air-breathing” cathode in which air in contact with the cathode provides oxygen to be reduced at the cathode surface. Although biofuel cell technology provides a number of advantages over conventional fuel cells and batteries, biofuel cells have thus far been incapable of meeting the power requirements for common consumer electronics. Consequently, much of the research on biofuel cell technology focuses on methods to improve the efficiency and capacity of electric energy production. These areas include optimization of anode and cathode compositions as well as the use of electron mediators to transfer electrons from biological reactions to the electrodes.

A brief survey of biofuel cell technology is provided by way of the following patent publications, incorporated by reference in their entirety. US 2003/0138674 (Zeikus, et al.) discloses a biofuel cell comprising anode and cathode compartments having electrodes and separated by a cation-selective membrane. Either the anode compartment or the cathode compartment comprises a solution that includes a cellular biocatalyst. US 2003/0198858 (Sun, et al.) and US 2003/0198859 (Ritts, et al.) disclose a fuel cell in which the anode compartment comprises an electrode and one or more dehydrogenase enzymes that transfer electrons from a carbohydrate fuel to an electron carrier, which transfer the electrons to the electrode. US 2004/0241528 (Chiao, et al.) disclose a miniaturized, implantable microbial fuel cell that extracts metabolites from body fluids for fuel to be used by yeast or bacteria at the anode. US 2005/0118494 (Choi) discloses an emplantable electrochemical cell having anode and cathode enzymes such as Glucose Oxidase and Laccase immobilized on high surface area metal nanowire or carbon nanotube electrodes.

The present invention provides a power supply for low power applications (less than one Watt) such as trickle charging to extend the charge of conventional batteries or to power devices such as microsensors, micropumps, and miniaturized medical devices.

### BRIEF SUMMARY OF THE INVENTION

The present invention is a flexible hybrid biofuel cell power strip for use in low power applications (less than one Watt) such as trickle charging to extend the charge of conventional batteries or to power devices such as microsensors, micropumps, and miniaturized medical devices. The power strip anode comprises carbon nanotubes (CNTs) that transfer electrons directly from the active center of the oxidation-reduction (redox) enzyme to a flexible, conductive anode substrate. This allows the building of surface architectures with pore structures customized for specific applications and enzyme substrate-containing media. The cathode comprises a catalytic layer of transition metal nanoparticle catalyst in contact with air or other source of oxygen. The flexibility of the power strip allows it to be shaped into a wide variety of conformations and applications including attachment to or implantation within living organisms.

### BRIEF DESCRIPTION OF THE SEVERAL VIEWS OF THE DRAWINGS

FIG. 1 is a cross-sectional view of the simplest configuration of a flexible power strip.

FIG. 2 is a cross-sectional view of a second embodiment of the power strip.

FIG. 3 shows a cross-sectional view of a power strip for use on a plant or animal.

FIG. 4 A-C shows a polarization curve, current vs. time, and power vs. time for a prototype.

### DETAILED DESCRIPTION OF THE INVENTION

The anode comprises one or more redox enzymes such as glucose oxidase (GOX) or laccase alone or in combination linked to a flexible anode substrate such as carbon paper or conducting polymer sheet through an integrated CNT/polymer network. The surfaces of the CNTs may be functionalized with carboxylate or amine groups, which can be use to form covalently linkages with redox enzyme. The presence of background polymer backbone enhances enzyme stability and can immobilize CNTs and redox enzyme to the flexible anode through covalent or noncovalent interactions. Exemplary polymers include charged polyethylene imine (PEI) or poly(p-phenyleneethylene) (PPE) with functional side chains. The CNT/polymer platform can immobilize and stabilize various redox enzymes. The anode support material can be conducting support such as carbon paper, printed carbon ink on polymer, or a conducting polymer or a non-conducting polymer such as Nafion® membrane polymer. If a non-conducting support such as Nafion® is used, the polymer/CNY/enzyme matrix serves as the conducting material.

The 3D pore structures of the CNT/polymer network can exhibit a large surface to volume ratios that enhance catalytic reaction rates. The CNT/GOx electrode provides direct electron transfer between the reactive center in the redox enzyme and the flexible anode substrate. This allows the present biofuel cell anode to operate at negative potentials close to the redox potential of the FAD/FADH₂ coenzyme normally used with glucose oxidase. Consequently, the present invention provides for the simplification and miniaturization of biofuel cell construction.

The cathode comprises a matrix of nanoparticles of platinum, or other conducting metal. CNTs, and a binding polymer such as low molecular weight Nafion® polymer immobilized on a flexible conducting substrate such as carbon paper or conducting polymer sheet or a non-conducting Nafion®) membrane. The cathode matrix may be constructed to produce 3-D highly porous structures that have large surface area-volume ratios. These structures provide large reaction areas and greater access for oxygen from the atmosphere.

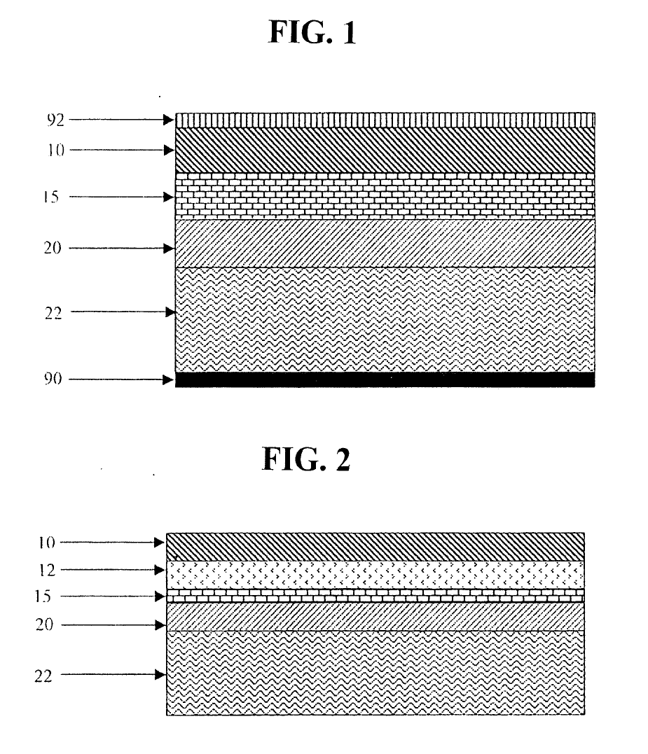

A cross-sectional view of the simplest configuration of a flexible biofuel cell strip is shown in FIG. 1. Cathode matrix 10 and Anode matrix 20 are both applied directly to a single Nafion® membrane 15. Cathode matrix 10 is in contact with the air or other oxygen-containing medium. Anode matrix 20 comprises a redox enzyme, CTNs, and a linking polymer and is in contact with an anolyte 22, an aqueous comprising an aqueous solution of enzyme substrate. The substrate serves as the fuel that is consumed at the anode. Cathode matrix 10 and Anode matrix 20 are each connected to electrical leads (not shown) that carry electrical current to an adapter for coupling to an electronic device. A wrapping material encloses the power strip. The wrapping material may be a flexible, water-tight polymeric film. The portion of the wrapper in contact with the cathode 92 may be perforated or made of a material that is more porous than the remainder of the wrapper 90 to allow oxygen or oxygen-containing media to contact the cathode matrix.

FIG. 2 shows a cross-sectional view of a second embodiment of the hybrid power strip additionally containing a catholyte 112 in contact with the cathode matrix 10. In this embodiment, Catholyte 12 is preferably an aqueous solution or gel comprising a butler that neutralizes hydroxide ions generated at the cathode. Phosphate buffered saline, pH 7.2, for example, is a preferred buffer solution. In the absence of catholyte 12, protons generated at the anode pass through membrane 15 to neutralize hydroxide ions generated by the cathode. The wrapping material is not shown.

The cathode matrix in this embodiment is immobilized on a support, or substrate (not shown), located at the interface between the cathode matrix and the catholyte. The substrate may be, for example, carbon paper, toray paper, graphite, or polymer film.

In some embodiments of the invention, including those shown in FIG. 1 and FIG. 2, it may be desirable to switch the position of anode matrix 20 with anolyte 22. For such embodiments, the anode matrix is immobilized on a support, or substrate, such as carbon paper, toray paper, graphite, or polymer film (not shown) that contacts the outer wrapping. CNTs, enzyme or microbial catalyst and linking polymer are immobilized on the support.

For some applications, it may be desirable to flow anolyte across the anode matrix. In such embodiments, one or more inlet/outlet ports through the wrapping material are used to allow anloyte to enter the power strip from a source of anolyte and to exit the power strip. This allows for replenishment of redox enzyme substrate to prolong power generation. Anloyte may flow through the power strip periodically, continuously unidirectionally, and/or tidally.

In some embodiments it may be desirable to prevent proton migration from the anode to the cathode or catholyte until the power strip is put into use. For such an embodiment, a removable, impermeable barrier may be placed between the anode and cathode compartments.

A power strip may be attached to an animal at a location that experiences flexing motion. One or more needles in liquid communication with the anolyte compartment of the power strip may be placed within the animal to access a bodily fluid such as blood or lymph such that movement of the animal causes flexing of the power strip to facilitate movement of the bodily fluid through the anolyte compartment.

A power strip may be attached to a plant such that needles in liquid communication with the anolyte compartment access fluid within the plant. Passive diffusion of enzyme substrate from the plant alone or in combination with fluid flow caused by capillary action or temperature or pressure changes are used to prolong power generation.

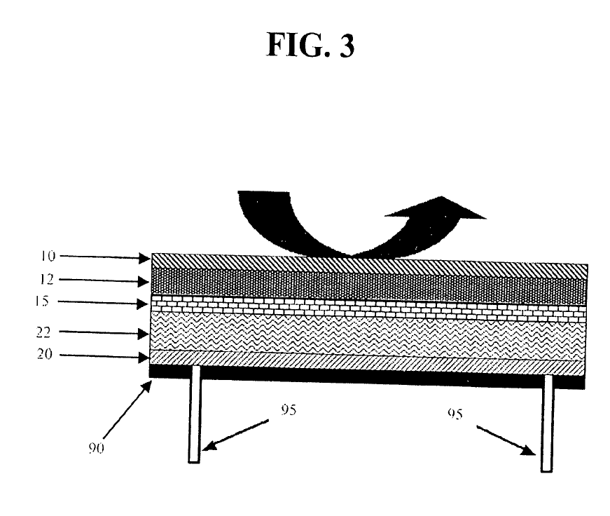

FIG. 3 shows a cross-sectional view of an exemplary embodiment of the power strip intended for use with a plant or animal. The air-breathing cathode matrix 10 comprises a catalytic layer or CNTs and transition metal catalyst nanoparticles dispersed in a polymeric matrix. A Nafion® membrane 15 separates the cathode from the anodic electrolyte 22 but allows selective transfer of H⁺ ions to the cathode. A porous carbon paper is used as substrate for cathode, and a printed carbon film is used as a substrate for the anode. Needles 95 penetrate into the animal to access bodily fluid containing enzyme substrate. Wrapping material 90 isolates the power strip from the animal.

The power strip may be adapted for implantation into an animal by using biocompatible wrapping material and a bodily fluid as a source of dissolved oxygen. An integrated microelectronic circuit and capacitor may be coupled to the electrodes of the power strip to store and release electrical energy on demand or in a programmed manner.

### EXAMPLE

### Power Strip Prototype

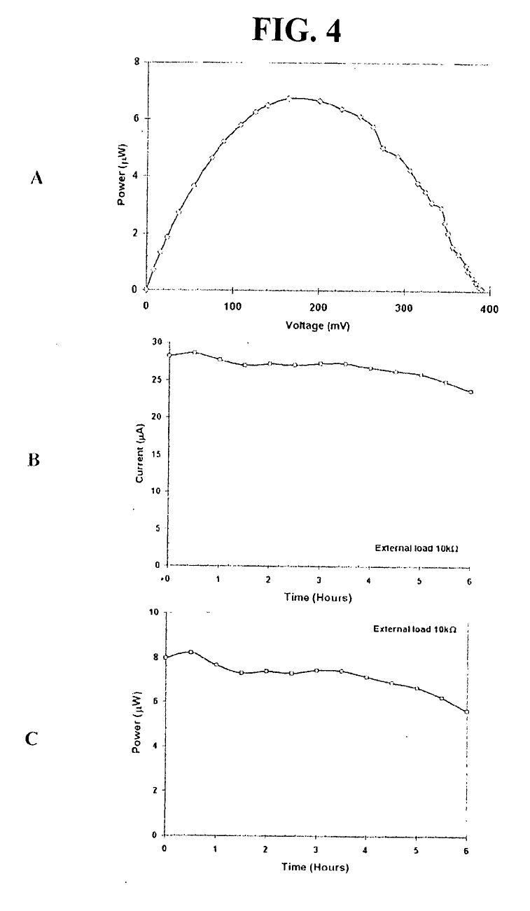

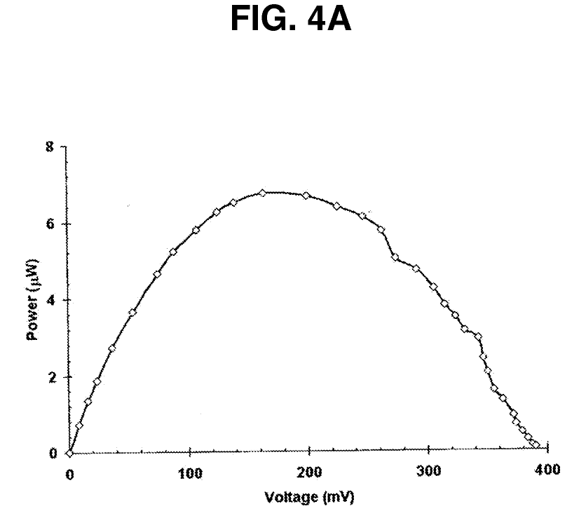

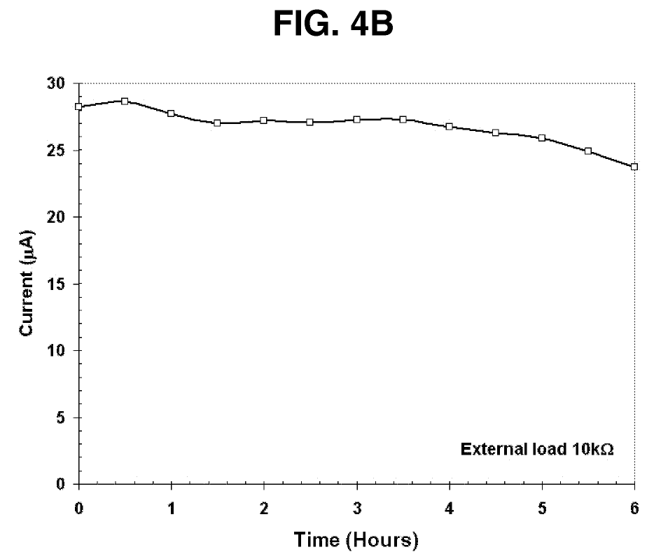

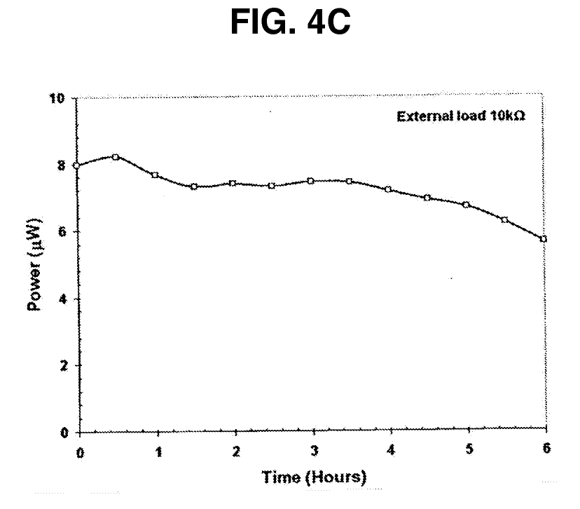

A power strip prototype having an area of approximately 2 cm² was built and demonstrated to generate electricity from glucose using glucose oxidase as the anodic enzyme. The configuration corresponds to that shown in FIG. 2 with the exception that locations of anode matrix 20 and anolyte solution 22 are reversed. The power strip generated a peak power of 7 μW at a voltage of about 175 mV. The current and power are found to be stable with time. A polarization curve, current vs. time, and power vs. time for the prototype are shown in FIG. 4 A-C.

Although particular embodiments of the present invention have been described, it is not intended that such references be construed as limitations upon the scope of this invention except as set forth in the claims.

What is claimed is:

1. A flexible biofuel cell strip apparatus comprising:
A. an anode comprising a flat, flexible, electrically conducting substrate, carbon nanotubes, a linking polymer, and a redox enzyme wherein the enzyme is linked to the linking polymer, the linking polymer is linked to the carbon nanotubes and the carbon nanotubes are linked to the flexible substrate;
B. a fuel compartment in contact with the anode comprising a substrate for the redox enzyme, wherein the substrate is suspended or dissolved in a gel, polymer matrix, or aqueous solvent;
C. a cathode separated from the fuel compartment by a proton permeable membrane, the cathode compromising a flat, flexible, electrically conducting substrate coated with a mixture of carbon nanotubes, polymer, and nanoparticles of conducting metal;
D. a flexible wrapping surrounding A, B, and C wherein the wrapping in contact with the cathode is permeable to oxygen in the atmosphere; and
E. at least two electric leads penetrating the wrapping, one each connected lo the anode and cathode, the leads adapted for attachment to recharge a battery or power an electronic device.

2. The apparatus of claim 1 wherein the anode cathode, and proton permeable membrane are planar and arranged in a laminate architecture and the normal distance between the anode and cathode is less than 1 inch.

3. The apparatus of claim 2 wherein at least 95% of the surface of the anode facing the fuel compartment is in contact with the fuel compartment and at least 95% of the cathode facing the proton permeable membrane is in contact with the proton permeable membrane.

4. The apparatus of claim 2 where in the apparatus is rolled into a coil and comprising a gap for air to access the oxygen permeable portion of the wrapping.

5. The apparatus of claim 2 wherein the apparatus is rolled into a cylinder with the oxygen permeable portion of the wrapping on the outer surface.

6. The apparatus of claim 1 wherein the carbon nanotubes on the anode are linked to the linking polymer through covalent bonds.

7. The apparatus of claim 1 wherein the linking polymer and enzyme are linked through covalent bonds.

8. The apparatus of claim 1 wherein the polymer is low molecular weight Nafion® polymer.

9. The apparatus of claim 1 further comprising a removable, flexible, proton impermeable barrier between the proton permeable membrane and either the cathode or the fuel compartment.

10. The apparatus of claim 1 wherein the linking polymer comprises PPE, PIE or a polypyrrole.

11. The apparatus of claim 1 wherein the fuel compartment is removable.

12. The apparatus of claim 1 wherein the wrapping comprises a sealable port to access the fuel compartment and replace the fuel.

13. The apparatus of claim 1 wherein the fuel compartment comprises a fluid from an organism.

14. The apparatus or claim 13 wherein the fluid from an organism is in fluid contact with the organism through one or more needles that connect the fuel compartment and the organism.

15. The apparatus of claim 1 wherein the redox enzyme is located in a living cell.

16. The apparatus of claim 15 wherein the living cell is selected from the group consisting of Rhodoferax ferrireducens, Geobacter sulfurreducens, Geobacter metallireducens, and Phanerochaete chrysosporium.

17. The apparatus of claim 1 wherein the redox enzyme is selected from the group consisting of Glucose Oxidase, Alcohol Oxidase, Alcohol Dehydrogenase, and Fructose Dehydrogenase and wherein the redox enzyme substrate is selected from the group consisting of Glucose, Ethanol, and Fructose.

18. The apparatus of claim 1 wherein the cathode further comprises a polymer matrix containing an aqueous solution or suspension.

19. The apparatus of claim 1 wherein the wrapping comprises a photovoltaic material (coated on or mixed with anode material).

20. The apparatus of claim 1 wherein the wrapping comprises two ports into the fuel compartment and substrate for the redox enzyme is circulated through the fuel compartment.

21. The apparatus of claim 1 wherein the redox enzyme is glucose oxidase and the substrate is glucose.

22. A flexible biofuel cell strip apparatus comprising:
A. an anode comprising a flat, flexible, electrically conducting substrate, carbon nanotubes, a linking polymer, and a redox enzyme wherein the enzyme is linked to the linking polymer, the linking polymer is linked to the carbon nanotubes and the carbon nanotubes are linked to the flexible substrate:
B. a fuel compartment in contact with the anode comprising a substrate for the redox enzyme, wherein the substrate is suspended or dissolved in a gel, polymer matrix, or aqueous solvent;
C. a cathode separated from the anode only by a proton permeable membrane, the cathode compromising a flat, flexible, electrically conducting substrate coated with a mixture of carbon nanotubes, polymer, and nanoparticles of conducting metal;
D. a flexible wrapping surrounding A, B, and C wherein the wrapping in contact with the cathode is permeable to oxygen in the atmosphere; and
E. at least two electric leads penetrating the wrapping, one each connected to the anode and cathode, the leads adapted for attachment to recharge a battery or power an electronic device.

23. The apparatus of claim 22 wherein the anode cathode, and proton permeable membrane are planar and arranged in a laminate architecture and the normal distance between the anode and cathode is less than 1 inch.

24. The apparatus of claim 23 wherein at least 95% of the surface of the anode facing the fuel compartment is in contact with the fuel compartment and at least 95% of the cathode facing the proton permeable membrane is in contact with the proton permeable membrane.

25. The apparatus of claim 23 where in the apparatus is rolled into a coil and comprising a gap for air to access the oxygen permeable portion of the wrapping.

26. The apparatus of claim 23 wherein the apparatus is rolled into a cylinder with the oxygen permeable portion of the wrapping on the outer surface.

27. The apparatus of claim 22 wherein the carbon nanotubes on the anode are linked to the linking polymer through covalent bonds.

28. The apparatus of claim 22 wherein the linking polymer and enzyme are linked through covalent bonds.

29. The apparatus of claim 22 wherein the polymer is low molecular weight Nafion® polymer.

30. The apparatus of claim 22 further comprising a removable, flexible, proton impermeable barrier between the proton permeable membrane and either the cathode or the fuel compartment.

31. The apparatus of claim 22 wherein the linking polymer comprises PPE, PIE or a polypyrrole.

32. The apparatus of claim 22 wherein the fuel compartment is removable.

33. The apparatus of claim 22 wherein the wrapping comprises a sealable port to access the fuel compartment and replace the fuel.

34. The apparatus of claim 22 wherein the fuel compartment comprises a fluid from an organism.

35. The apparatus of claim 34 wherein the fluid from an organism is in fluid contact with the organism through one or more needles that connect the fuel compartment and the organism.

36. The apparatus of claim 22 wherein the redox enzyme is located in a living cell.

37. The apparatus of claim 36 wherein the living cell is selected from the group consisting of Rhodoferax ferrireducens, Geobacter sutlfurreducens, Geobacter metallireducens, and Phanerochaete chrysosporium.

38. The apparatus of claim 22 wherein the redox enzyme is selected from the group consisting of Glucose Oxidase, Alcohol Oxidase, Alcohol Dehydrogenase, and Fructose Dehydrogenase and wherein the redox enzyme substrate is selected from the group consisting of Glucose, Ethanol, and Fructose.

39. The apparatus of claim 22 where in the cathode further comprises a polymer matrix containing an aqueous solution or suspension.

40. The apparatus of claim 22 wherein the wrapping comprises a photovoltaic material (coated on or mixed with anode material).

41. The apparatus of claim 22 wherein the wrapping comprises two ports into the fuel compartment and substrate for the redox enzyme is circulated through the fuel compartment.

42. The apparatus of claim 22 wherein the redox enzyme is glucose oxidase and the substrate is glucose.

43. A method for harvesting electrical energy from a living organism comprising: a flexible biofuel cell strip comprising:
A. an anode comprising a flat, flexible, electrically conducting substrate, carbon nanotubes, a linking polymer, and a redox enzyme wherein the enzyme is linked to the linking polymer, the linking polymer is linked to the carbon nanotubes and the carbon nanotubes are linked to the flexible substrate;
B. a fuel compartment in contact with the anode comprising a substrate for the redox enzyme, wherein the substrate is suspended or dissolved in a gel, polymer matrix, or aqueous solvent;
C. a cathode separated from the anode only by a proton permeable membrane, the cathode compromising a flat, flexible, electrically conducting substrate coated with a mixture of carbon nanotubes, polymer, and nanoparticles of conducting metal;
D. a flexible wrapping surrounding A, B, and C wherein the wrapping in contact with the cathode is permeable to oxygen in the atmosphere; and
E. at least two electric leads penetrating the wrapping, one each connected to the anode and cathode, the leads adapted for attachment to recharge a battery or power an electronic device; wherein:
the fuel compartment of the flexible biofuel cell strip is in liquid communication with a fluid within an organism via at least one needle.

44. The method of claim 43 wherein the organism is a plant and the fuel compartment is in liquid communication with a fluid within said plant.

45. The method of claim 44 wherein the plant is a tree and the fluid within said plant is sap.

46. The method of claim 43 wherein the organism is an arthropod and the fuel compartment is in liquid communication with a fluid within said arthropod
